(19) United States
(12) Patent Application Publication
(10) Pub. No.: US 2025/0077898 A1
(43) Pub. Date: Mar. 6, 2025

(54) MACHINE LEARNING METHODS TO PRODUCE GENERAL STRUCTURED PREDICTIONS FROM GLOBAL EVENT DATA FOR THE PAST, PRESENT AND FUTURE

(71) Applicant: Christoph Adam Kohlhepp, Midge Point, QLD (AU)

(72) Inventor: Christoph Adam Kohlhepp, Midge Point, QLD (AU)

(21) Appl. No.: 18/811,904

(22) Filed: Aug. 22, 2024

Related U.S. Application Data
(60) Provisional application No. 63/534,356, filed on Aug. 24, 2023.

(30) Foreign Application Priority Data
Aug. 22, 2023 (AU) 2023902684
Aug. 23, 2023 (GB) 2312868.9

(51) Int. Cl. G06N 5/02; G06N 3/042

(52) U.S. Cl. CPC G06N 5/02; G06N 3/042

(57) ABSTRACT

A computer-implemented method comprising a mathematical formulation of the social energy flow of Karma and a machine learning framework combining mathematical graph computation, which form a global sentiment aggregator for the measurement of social energy flows and which is formulated as a data processing, filtering and sampling framework which fuses structural, interpretable graph machine learning with graph neural networks and introduces a Graph Attention Mechanism (GAM) whereby machine learning guides an interpretable graph computation substrate in order to generate general, structured predictions for the past, present and future. This enables the framework to handle large data sets on a global scale in the graph neural network while affording interpretability within the less scalable graph computational substrate which in turn optimizes the use of memory, computer storage and processing power over traditional designs, thereby making global-scale computations on commodity hardware feasible.

### CROSS-REFERENCE TO RELATED APPLICATIONS

The present application claims priority to Australian Provisional Patent Application serial number 2023902684, filed on 22 Aug. 2023 and United Kingdom Patent Application number 2312868.9, filed on 23 Aug. 2023 and U.S. Provisional Patent Application No. 63/534,356, filed on 24 Aug. 2023, the disclosures of which are hereby incorporated in their entirety at least by reference. Further, the present disclosure incorporates at least by reference the following Social Science Research Network (SSRN) research publications:
Karma Flows, A Strategy for Measuring Social Energy Flows using Graph Computation and Artificial Intelligence, A Global Sentiment Aggregator (Aug. 27, 2023). Available at SSRN: https://ssrn.com/abstract=4550766 or http://dx.doi.org/10.2139/ssrn.4550766
Karma Flows Political Wire—Forecasting the US Presidential Elections 2024 (Mar. 14, 2024). Available at SSRN: https://ssrn.com/abstract=4759179 or http://dx.doi.org/10.2139/ssrn.4759179

### SUMMARY OF THE INVENTION

The described technology introduces a mathematical formulation of the social force of Karma and a machine learning framework combining mathematical graph computation and artificial intelligence, which form a global sentiment aggregator for the measurement of social energy flows. The described technology is formulated as a data processing, filtering and sampling framework, called Karma Flows, which fuses structural, interpretable graph machine learning with graph neural networks, in particular graph deep learning, and introduces a Graph Attention Mechanism (GAM) whereby deep learning guides an interpretable graph computation substrate in order to move from a paradigm of “Human Driven & Machine Assisted” to a paradigm of “Machine Guided & Human Evaluated.” This design enables the framework to handle large data sets on a global scale in the graph neural network while affording interpretability within the less scalable graph computational substrate. This in turn enables the framework to optimize the use of memory, computer storage and processing power over traditional designs, thereby making global-scale computations feasible on comparable hardware that previously were not.

At the core of the data processing framework, we introduce an Iterative Graph Regularizer (IGR), called Karma Scope, which acts as a noise filter eliciting dominant social energy flows of Karma. Karma Scope houses the Graph Attention Mechanism (GAM) used by the deep learning graph to guide the noise filter to elicit dominant social energy flows of Karma whereby it is possible to determine which social energy flows receive the focus of an analysis. Human operators are also able to guide Karma Scope directly using the Graph Attention Mechanism (GAM) to allow manually guided analyses.

Karma Flows enables investigators to identify leading influencers in news events, quantify the news negativity bias, attribute both likely endorsement and likely blame for news events to specific entities as well as identify hidden collaborators. Crucially, Karma Flows allows investigators to structurally predict (foresight) the general future, structurally nowcast (foresight) the general present and structurally interpret (gain insight) the general past. Additionally, Karma Flows allows the quantitative measurement of relatedness of entities such as persons, organizations, countries, or places to thematic concepts such as economic volatility or security threats, both in the present and future and to quantify the positivity or negativity of such relatedness. For instance, an investigator might ask if an organization is positively or negatively related to economic volatility—now and in the near future—and quantify this relatedness to facilitate objective comparisons. Crucially, and leaning on the notion of General Artificial Intelligence, Karma Flows can use the newly introduced formulation of Karma to make general predictions for the future, rather than predictions constrained to a particular domain or discipline, as is customary with present Machine Learning technology in the prior art.

### COPYRIGHT NOTICE

A portion of the disclosure of this patent document contains material, which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNICAL FIELD

The present disclosure relates generally to systems, apparatuses, and methods for producing general structured forecasts for the future and producing general structured nowcasts for the present and producing general structured interpretations for the past using graph machine learning.

### BACKGROUND

Machine Learning is a subdiscipline of Artificial Intelligence. Dominant machine learning models are typically narrowly focused, for instance, on time series prediction or image recognition. Practitioners of Artificial Intelligence have long pursued horizons further afield and looked towards the concept of General Artificial Intelligence, whereby machines can reason and think independently, drawing on both past learning and contextual knowledge in a structured way, as do humans. It is generally accepted that General Artificial Intelligence has yet to be realized, although progress has been made in the area of Large Language Models, for instance, ChatGPT, which give the appearance of structured thought and can draw on a large body of knowledge and context. The appearance of structured thought of Large Language Models is rooted in the statistically dominant connections found within the latent graph structures of the language corpus on which said Large Language Models have been trained. General Artificial Intelligence is still the “Holy Grail” of the industry.

While there is much talk about Machine Learning and Artificial Intelligence replacing human activity, such as in self-driving cars, Machine Learning is applied particularly in areas where due to scale, complexity, dimensionality or another intractability (for instance NP-Completeness) of a problem, the solution in the abstract eludes human cognition and therefore is inextricably tied to a machine-implemented approach.

Graph Machine Learning, as a subdiscipline of Machine Learning, is the application of machine learning to graphs specifically for predictive and prescriptive tasks. In this context, “graphs” means graph data structures as defined in the field of software engineering and implemented on a computer for the purposes of machine learning to tackle problems, which as previously described, elude human cognition, for instance, eliciting patterns from global scale news data. Graph Machine Learning tasks include Community Detection, Centrality, Path Finding and Link Prediction. Problems on the scale of global news data tend to be punishing on hardware constraints of computers implementing solutions for these problems, in particular memory and storage, which means data scientists are always looking for ways to shrink these problems to fit hardware constraints, either with a view towards utilizing commodity hardware for cutting edge problems or with a view towards expanding the horizon of what problems can feasibly be tackled with cutting edge hardware. One of the ways of shrinking large-scale problems in data science is Regularization.

Regularization in mathematics, statistics and machine learning is a technique to constrain a model's complexity, often by means of reducing the model's ability to cope with a level of detail or by removing said detail from the model, which in turn forces the model to abstract. It is this abstraction which represents learning. The technique also reduces overfitting, which otherwise occurs when the model simply remembers what it has seen. A model that has been overfit is unable to deal with future settings which, although similar to settings it has been trained on, differ slightly from the settings it has been trained on. Broadly, since transformation takes more energy than recollection, learning occurs primarily because complexity must be reduced. Taking the example of a price time series of an equity on a stock exchange, there may be many swings in price as well as erratic jitters. A well-tuned regularizer would remove the jitters while retaining the swings in price, thereby allowing an analyst to interpret major movements in price or allowing a machine learning model to predict the next most important movements in price.

There is a tension between machine learning models rooted in well-founded mathematical concepts which are readily explainable and can be trained on small to medium-sized data sets and deep learning models which are highly dimensional, require large data sets but which are frequently uninterpretable in a structured way. The industry calls the latter “black box” models. Most machine learning models which made waves in the news in the recent past have been deep learning models. Deep learning models tend both to be able to cope with large data sets while at the same time requiring them for successful training. Recent breakthroughs in deep learning, in particular in Large Language Models, can be attributed to so-called attention mechanisms in Transformer Models which superseded the earlier deep learning techniques of recurrence and convolution: “This type of artificial attention may be seen as a form of iterative re-weighting. Specifically, it dynamically highlights different components of a pre-processed input as they are needed for output generation. This makes it flexible and context-dependent, like biological attention. “^{[Attention in Psychology, Neuroscience, and Machine Learning}. Grace W. Lindsay”,^{2020]}

Large Language Models are Open Knowledge Graphs, which means there is a fundamental correspondence, if not equivalence, between graphs and language models. Indeed, research has shown that it is possible to extract the graph representation of Large Language Models as open knowledge graphs.

Merriam-Webster defines Karma as “a characteristic emanation, aura, or spirit that infuses or vitalizes someone or something.”^{[Merriam-Webster]}

Society and the interactions within society may be modelled as knowledge graphs. Existing projects do model human society and its interactions in such terms: “The GDELT Project is a real-time open data global graph over human society as seen through the eyes of the world's news media, reaching deeply into local events, reaction, discourse, and emotions of the most remote corners of the world.”^{[www.gdeltproject.org]}

The World Bank Group (WBG) Topical Taxonomy “is a classification schema which represents the concepts used to describe the World Bank Group's topical knowledge domains and areas of expertise—expertise—the ‘what we do’ and ‘what we know’ aspect of the Bank's work. The WBG Taxonomy provides an enterprise-wide, application-independent framework for describing all of the Bank's areas of expertise and knowledge domains, current as well as historical, representing the language used by domain experts and domain novices, and Bank staff and Bank clients.”^{[World Bank Group]} “The World Bank Group Topical Taxonomy covers an incredible range of subjects, from Agriculture & Food Security to Education, Fragility to Gender, Health to Social Development, Urban Development to Water issues.”^{[www.gdeitproject.org]}

Conflict and Mediation Event Observations (CAMEO) is a framework for coding event data typically used for events that merit news coverage and is frequently applied to the study of political news and violence.

The Goldstein Scale for event severity is a widely used expert-based measure that scores events on a conflictual—cooperative scale. The Goldstein Scale uses an intensity ranking of the 20 CAMEO action categories ranging between −10.0 (conflictual) to +10.0 (cooperative).

### BRIEF DESCRIPTION OF THE DRAWINGS

FIG. 1. is a diagram showing the contextual environment of the described technology in one embodiment of the present invention.

FIG. 2. is a diagram showing the software block architecture of the described technology in one embodiment of the present invention.

FIG. 3. is a diagram showing the Karma Flows graph schema of the described technology in one embodiment of the present invention.

FIG. 4. is a diagram showing the workflow in Large Language Models and the role of attention learning in Large Language Models.

FIG. 5. is a diagram showing the workflow in Karma Flows and the corresponding role of its attention mechanism of the described technology in one embodiment of the present invention as it contrasts with attention learning in Large Language Models in FIG. 4.

FIG. 6. is a flow chart showing the logic of the described technology in one embodiment of the present invention.

FIG. 7. is a flow chart showing the logic of the Karma Scope regularizer of the described technology in one embodiment of the present invention.

FIG. 8. is a hardware diagram showing components of a typical computer system on which elements of the described technology may execute in one embodiment of the present invention.

FIG. 9. is a diagram depicting an example environment within which elements of the described technology may execute in one embodiment of the present invention.

### DETAILED DESCRIPTION

### Summary

The implementation of the described technology is described by providing the formulations of Karma, Sentiment Bias and Aura and the Karma Flows framework, which accommodates these formulations using a dual graph model: one graph is implemented as an interpretable graph machine learning model; the other graph is implemented as a deep graph neural network model. Both graphs record a large temporal language corpus of news data with associated events and sentiments. The deep graph neural network model guides a Graph Attention Mechanism (GAM) introduced by Karma Flows that operates within an Iterative Graph Regularizer (IGR). The Graph Attention Mechanism (GAM) as introduced by Karma Flows is termed “retentive,” also referred to as a Retention Attention Mechanism (RAM) owing to the fact that it operates by iterative retention of connections within the graph rather than by re-weighting of connections within a neural network. The Iterative Graph Regularizer extracts statistically dominant relationships from the large language corpus within the graph data and, combined with predictions from the deep graph neural network model, derives insight and foresight from the identified relationships.

### DETAILED DESCRIPTION OF THE DRAWINGS

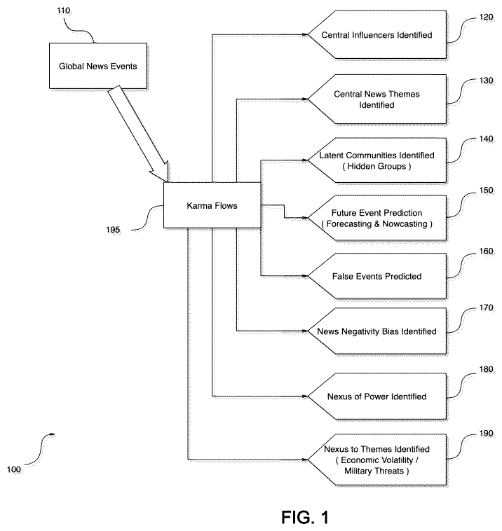

Certain details are set forth in the descriptions of FIGS. 1-9 to provide a thorough understanding of various embodiments of the present disclosure. A person of ordinary skill in the relevant art will understand that the present disclosure may have additional embodiments that may be practised without several of the details described below. In other instances, those of ordinary skill in the relevant art will appreciate that the methods and systems described can include additional details without departing from the spirit or scope of the disclosed embodiments.

As per the above, the descriptions in paragraphs to are implementations of the present disclosure.

Referring to diagram 100 of FIG. 1, depicting the contextual environment of Karma Flows and its high-level use case, the described technology reads global news events 110 and assists human investigators by identifying the central influencers 120 involved in the news events, by identifying the core news themes 130 within the news events, by identifying latent (hidden) groups or collaborators 140 within the news events, by predicting events about to occur in the future or which may have occurred already but failed to be reported 150, by predicting events which ought not to have been reported 160 such as false news, by identifying the news negativity bias 170, by identifying nexus of power 180 between entities and by identifying connections 190 between entities and themes such as economic volatility or governmental themes.

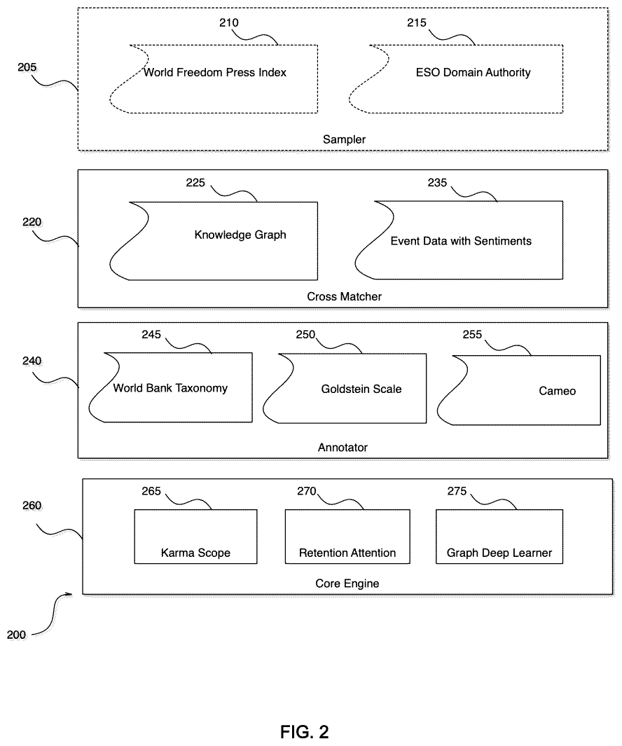

Referring to diagram 200 of FIG. 2, depicting the software block architecture of Karma Flows, the described technology comprises four key architectural layers: the Sampler layer 205, the Cross Matcher layer 220, the Annotator layer 240 and the Core Engine layer 260. The Sampler layer 205 implements sub-sampling based on the World Freedom Press Index 210 and the Enterprise Search Optimization (ESO) Domain Authority 215 in order to improve the trust in the retained data set. The Cross-Matcher layer 220 connects individual events with sentiments 235 with entities in the knowledge graph 225 using Natural Language Processing Named Entity Recognition. The Annotator layer 240 implements the markup of the knowledge graph with World Bank Taxonomy 245 themes and concepts, the markup of event sentiment with the corresponding severity of events using the Goldstein Scale 250 and, according to the CAMEO event classification system 255. The software system's Core Engine layer 260 implements the Karma Scope graph regularizer 265 with its associated Retention Attention Mechanism (RAM) 270 and the Retention Attention guidance system implemented as a graph machine deep learner 275.

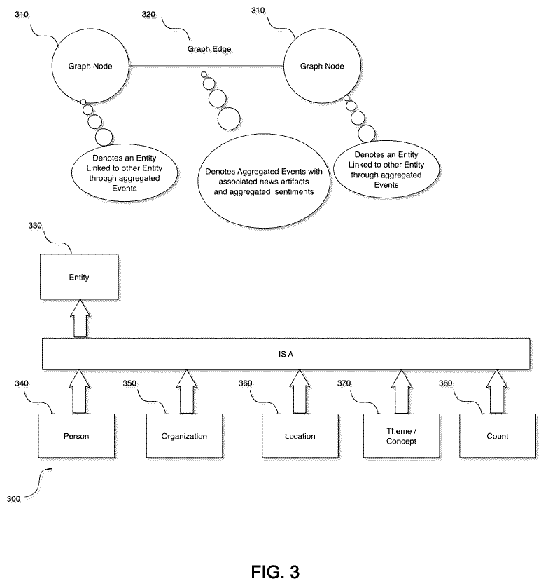

Referring to diagram 300 of FIG. 3, depicting the Karma Flows graph schema, the described technology utilizes a knowledge graph with the core graph schema: entity 310 to aggregated events with aggregated sentiments 320 to entity 310. In graph theory this is also referred to as a triplet: graph nodes are entities; graph edges are aggregated events & sentiments. In other embodiments of the present invention, nodes and edges may have additional properties adding dimensionality to the graph. As this is the only triplet in the graph, the graph is referred to as homogeneous. Prior to aggregation, the graph is a multi-graph. Post aggregation, the graph is a simple graph. Karma Flows performs said aggregation. Entities 330 may be Persons 340, Organizations 350, Locations 360, Themes or Concepts 370 or Counts 380. Alternative embodiments of the described technology may choose to implement this schema as a heterogeneous graph whereby each entity type is represented as a different node type in the schema.

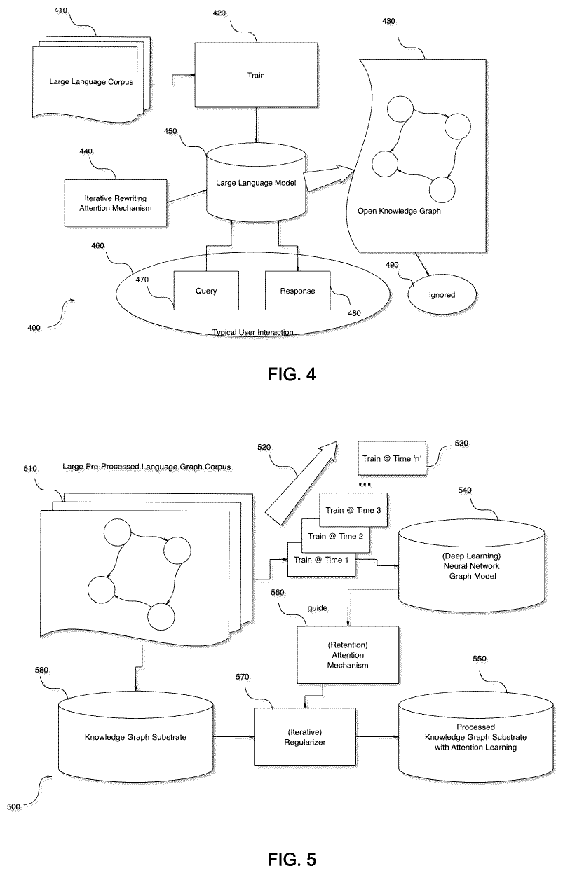

Referring to diagram 400 of FIG. 4, depicting the workflow in traditional Large Language Models and the role of attention learning 440 in Large Language Models and together referring to diagram 500 of FIG. 5, depicting a diagram showing the contrasting workflow in Karma Flows and the corresponding role of its attention mechanism 560, the described technology implements a new kind of attention mechanism 560 and applies this to the process of regularization 570 of knowledge graphs. The attention mechanism 440 in traditional Large Language Models 450, typically based on a machine learning technique referred to as Transformers, is additive: it builds neural network connections in the model 450 through iterative re-weighting as data from the large language corpus 410 is applied during training 420. After training, the typical use case 460 of a traditional Large Language Model is one of language query 470 and linguistic response 480. The query-response process is a “black box” in that the open knowledge graph 430 embedded within the model is typically ignored 490 and, in either event, cannot be directly queried for its graph-theoretical properties.

Further referring to diagram 400 of FIG. 4, and to diagram 500 of FIG. 5, the attention mechanism 560 in Karma Scope, by contrast, is retentive: it retains features as the regularizer 570 iteratively removes detail and complexity from a graph model 580, which serves as a substrate for a deep learning graph model 540. Rather than gradually building up dominant statistical properties as do traditional Large Language Models using Transformers, we begin with a large preprocessed graph corpus 510 rooted in language and over time 520 and through time steps ‘1’ through ‘n’ 530 refine a neural network deep learning graph model 540 to guide the Retention Attention Mechanism 560 to assist the Iterative Regularizer 570 in eliciting dominant statistical properties in the refined graph model 550 but with a focus on areas of attention. Whereas a Large Language Model process using Transformers may be regarded as additive, the Karma Scope process may be regarded as subtractive. As a result, we directly obtain an open knowledge graph modelling our large language corpus, but which we may query directly for its structure and graph theoretical properties.

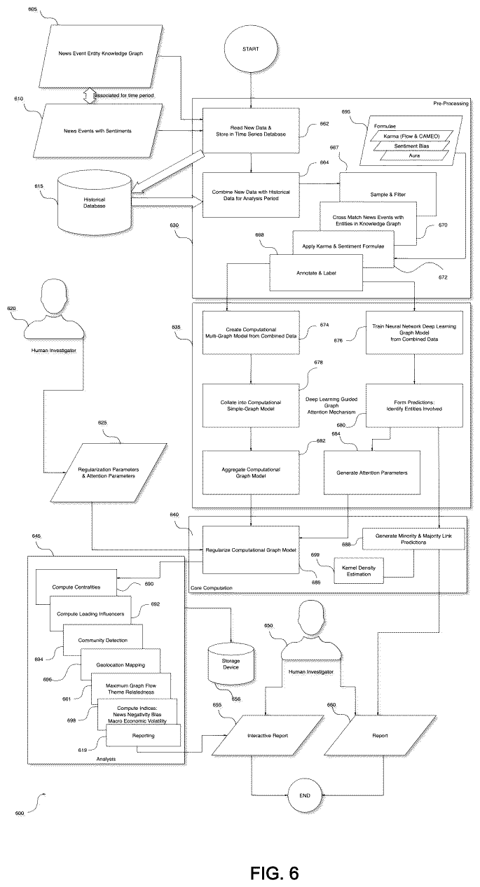

Referring to diagram 600 of FIG. 6, depicting a flow chart showing the logic of Karma Flows, the described technology comprises four process groups: Pre-Processing 630. Deep Learning Guided Graph Attention Mechanism 635, Core Computation 640 and Analysis 645.

Further referring to diagram 600 of FIG. 6, Pre-Processing 630 reads 662 a preprocessed language corpus comprising a temporal news event entity knowledge graph 605 for the time period for which an analysis is to be performed and news events with sentiments 610 for said time period and stores the graph 605 with said news events with sentiments 610 in a database 615 combining 664 both data sets 605 and 610 into a single data set. Said data set is then sampled and filtered 667. During sampling and filtering, inputs from less trustworthy sources are removed based on the World Press Freedom index and the domain authority of source URLs of the data. Said sampling and filtering 667 is aimed at increasing trust in the data and broadly amounts to an editorial process at a publisher who removes from their submissions the bad manuscripts from the good manuscripts. Cross matching 670 then matches events 610 in the data set with entities in the knowledge graph 605 whereby a unified data set of nodes representing entities and edges representing events is created. At this stage, karma, sentiment & aura are pre-computed & applied 672 to said unified data set of nodes representing entities and edges representing events. Said unified data set is then annotated and labelled 668—during this stage the data is categorized whereby, for instance, it is determined where macroeconomic relevance exists.

Further referring to diagram 600 of FIG. 6, the Deep Learning Guided Graph Attention Mechanism 635, has two parallel streams. Stream 1 comprises three processes: create a computational multi-graph model from said unified data set of edges representing events and nodes representing entities 674; collate said multi-graph model into a simple graph model 678; and aggregate the computational graph model 682. It is during this last process, that the mathematical formulations of Karma, Sentiment Bias and Aura as aggregate formulations are finalized from the pre-computed formulations in step 672. The computational graph model is now ready for regularization and for guided analysis using the attention mechanism from stream 2. Stream 2 comprises three processes: train a neural network deep learning graph model from said unified data set of edges representing events and nodes representing entities 676; form predictions to identify entity pairs in said unified data set whereby associations are identified which should exist in said unified data set but which do not and whereby associations are identified which should not exist in said unified data set but which do 680; generate attention parameters 684 from the entity pairs identified in process 680.

Further referring to diagram 600 of FIG. 6, Core Computation 640 comprises two processes: combine the aggregated computational graph model from process 682 and the attention parameters from process 684 to regularize said aggregated computational graph model using the Graph Attention Mechanism 640 whereby statistically dominant features are extracted from said aggregated computational graph model and whereby a regularized computational graph model is created; and a minority link prediction report and a majority link prediction report is formulated 688 using said predictions produced in process 680 and applying Kernel Density Estimation (KDE) 699 to further predict the Karma associated with said predictions produced in process 680. Said majority link prediction report yields combined foresight and insight into events which either have not occurred yet but are likely to occur in the future or are likely to have occurred already but are yet to be reported while the minority link prediction report yields insight into events which should not be reported—this suggests that either the reports are false or that the events were highly improbable to have occurred.

Further referring to diagram 600 of FIG. 6, Analysis 645 comprises 6 processes: computing centralities 690 whereby leading influencers are identified 692; community detection 694 whereby latent (hidden) groups and collaborators are identified; maximum graph flow relatedness computation 661 wherein the relatedness of entities to specific themes, such as macroeconomic volatility is quantified using the maximum graph flow between said entities and said specific themes; geolocation mapping 696; computation of indices such as news negativity bias and macroeconomic volatility index 698; and reporting whereby all results of analysis 645, core computation 640 and pre-processing 630 are written to storage device 656.

Further referring to diagram 600 of FIG. 6, interactive report 655 allows a human investigator 650 to explore the analysis 645 being produced. Said report may be an interactive website or an interactive application. Additionally, said majority link prediction report and said minority link prediction report are collated into a unified report 660 for analysis by a human investigator 650.

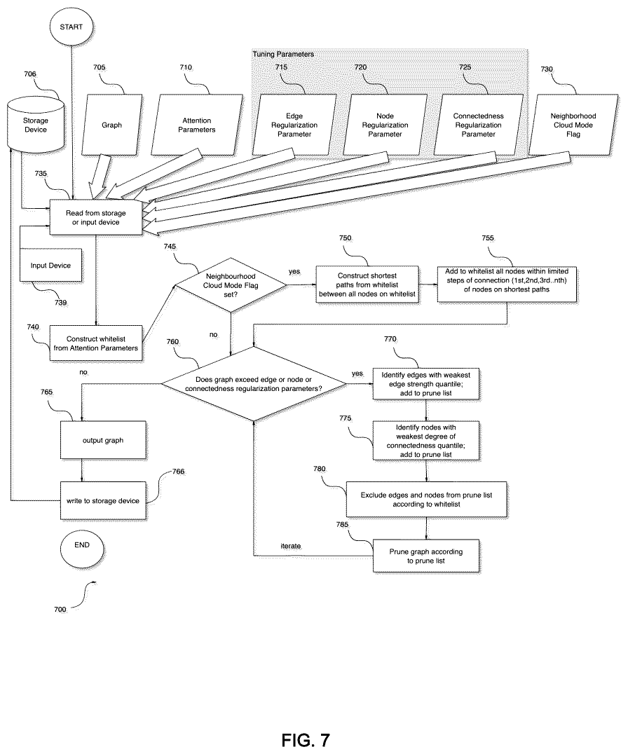

Referring to diagram 700 of FIG. 7, depicting a diagram showing the logic of the Karma Scope regularizer as a detailed view of process 682 of diagram 600 of FIG. 6, process 735 reads from storage device 706 or input device 739 the following parameters: said simple graph model 705 as produced by process 678 of diagram 600 of FIG. 6, Attention Parameters 710 as produced by process 684 of diagram 600 of FIG. 6, Edge Regularization Parameter 715, Node Regularization Parameter 720, Connectedness Regularization Parameter 725, and the Neighborhood Cloud Mode Flag 730. Process 740 constructs a whitelist from the Attention Parameters; entities on the whitelist represent nodes of interest on said simple graph model. Process 745 checks if the Neighborhood Cloud Mode Flag 730 is set. If yes, said whitelist is amended according to processes 750 and 755. Process 750 constructs the shortest paths from said whitelist between all nodes on said whitelist. On a graph, the shortest path between any two nodes is a list of all intermediate nodes on the shortest path between said two nodes. Process 755 then adds to said whitelist all nodes within a pre-set limited steps of connections (direct neighbour/neighbour once removed/neighbour twice removed/neighbour n-steps removed) of said intermediate nodes on said shortest paths as constructed by process 750. Process 760 then checks if the graph exceeds edge or node or connectedness regularization parameters. Process 760 is the main iterative process in the Karma Scope regularizer. If the graph exceeds edge or node or connectedness regularization parameters, the workflow proceeds with processes 770, 775, 780 and 785 and then returns to process 760. Process 770 identifies edges with the weakest edge strength quantile according to a pre-set threshold and adds said edges to a prune list. Process 775 identifies nodes with the weakest degree of connectedness quantile according to a pre-set threshold and adds said nodes to said prune list. Process 780 excludes edges and nodes from said prune list according to the whitelist. Process 785 prunes graph model 705 according to said prune list whereby graph model 705 is iteratively refined to retain only statistically dominant relationships within the graph model. The workflow then returns to process 760 mentioned above to determine if the graph exceeds edge or node or connectedness regularization parameters. When the graph does not exceed edge or node or connectedness regularization parameters, the output 765 of the Karma Scope regularizer is the constrained graph model with only statistically dominant relationships of the input graph model 705 as well as areas of the graph retained as identified collectively by the attention parameters 710 and the Neighbourhood Cloud Mode Flag 730. Process 765 writes said output to storage device 706.

### Computing Environment

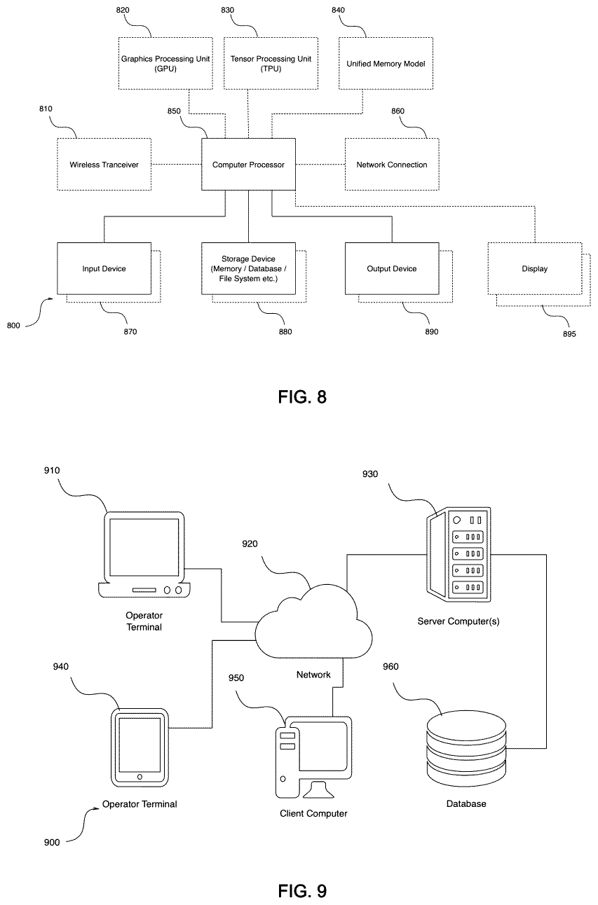

FIG. 8 and the following discussion provide a brief general description of a suitable computing environment in which aspects of the described technology can be implemented. Although not required, aspects of the technology may be described herein in the general context of computer-executable instructions, such as routines executed by a general- or special-purpose data processing device (e.g. a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, Tensor Processing Units (TPU's), Graphics Processing Units (GPU's), or other data storage media. Alternatively, computer-implemented instructions; data structures, screen displays, and other data related to the technology may be distributed over the Internet or other networks (including wireless networks) on a propagated signal on a propagation medium (e.g. an electromagnetic wave, a sound wave etc.) over a period of time. In some implementations, the data may be provided on any analogue or digital network (e.g., packet-switched, circuit-switched, or other scheme).

The described technology can also be practised in distributed computing environments, where tasks or modules are performed by remote processing devices, which are linked through a communications network, such as a Local Area Network (“LAN”), Wide Area Network (“WAN”), Tensor Processing Units (TPUs), Graphics Processing Units (GPUs), or the Internet. In a distributed computing environment, program modules or subroutines may be located in both local and remote memory storage devices. Those skilled in the relevant art will recognize that portions of the described technology may reside on a server computer while corresponding portions reside on a client computer (e.g., PC, mobile computer, tablet, or smartphone). Data structures and transmissions of data particular to aspects of the technology are also encompassed within the scope of the described technology.

Referring to FIG. 8, the described technology employs a computer, such as a personal computer, workstation, phone, or tablet, having one or more processors 850 coupled to one or more user input devices 870 and data storage devices 880. The computer is also coupled to at least one output device 890, such as a display 895. The computer may be coupled to external computers, such as via an optional network connection 860, a wireless transceiver 810, or both. For example, network hubs, switches, routers, or other hardware network components within the network connection 860 and/or wireless transceiver 810 can couple one or more computers.

The input devices 870 may include a keyboard and/or a pointing device such as a mouse. Other input devices are possible. The storage devices 880 may include any type of computer-readable media that can store data accessible to the computer, such as magnetic hard and floppy disk drives, optical disc drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a node on a network, such as LAN, WAN, or the Internet (not shown in FIG. 8).

FIG. 9 is a diagram illustrating an example environment 900 within which the described technology may operate. Environment 900 may include operator terminals (nodes) 910 and 940, and client computers (nodes) 950 on a network 920 from which human investigators may operate Karma Flows. Servers 930, in some embodiments, are dedicated or partially dedicated nodes that facilitate various aspects of the described technology. Servers 930 may also be coupled to one or more databases 960.

### Karma Formulation

We define Karma lexically as “the sum of someone's actions, a characteristic emanation or aura that infuses someone or something.” The essence of Karma may be thought of as “sentiment with impact.” In the context of society, we regard Karma as the social energy flow that compels entities towards action. We observe similar dynamics at stock exchanges where order books collate price levels with bids and offers representing the sentiments of traders and which distil towards what is called the base weight for the instrument being traded. When price pressures build sufficiently in the direction of either bids or offers, prompting a shift in the base weight, then trade events occur. In physics (thermodynamics) all energy build-up in a connected system results in the transfer (flow) of energy along the lines of connection. In human society, sentiment represents emotional energy which precipitates action. In aggregate, that action becomes predictable. It is this we model as Karma and its flow through society.

Whereas the appearance of structured thought of Large Language Models is rooted in the statistically dominant connections found within the latent graph structures of the language corpus on which said Large Language Models have been trained, Karma Flows implements a new approach wherein Karma is elicited by aggregating statistically dominant associations between named entities within a structured knowledge graph formed over a large language corpus of news events by aggregating sentiment across said events described in the dominant associations between the named entities wherein said sentiment is weighted according to the connection strength of said dominant associations and weighted according to the gravity of said events.

The elements of the definition of Karma are discussed in paragraphs [0041] to [0047].

Sum means an aggregate.

Someone means an entity. This need not be a person. It may be a corporation, an organization, a country or a place. Indeed, it may not be an embodied entity. Art influences culture. Culture influences people. People do things. In seeking to capture this dynamic, entities must therefore include abstract concepts and themes.

Actions mean events; the things that people do. People do things to others. This means we need to represent associations between entities. Entities and their associations are mathematically represented by graph theory. In today's society, actions are recorded by news media and the dissemination of news, chiefly on the Internet.

Emanation—means the tone or sentiment that actions evoke.

Aura—means the aggregation of sentiments about an entity as resulting from the flow of karma between the said entity and other entities.

Infusion—means the echo created by the gravity of events and actions. Sentiments are ephemeral unless they make an impression, not merely on the recipient of an action, or the outcome of the event, but on those registering the sentiment expressed by third parties. For example, an investor who puts their hard-earned dollars into a pharmaceutical stock in response to the euphoric article by a journalist detailing how the company behind the stock just invented a cure for a previously incurable disease, has been infused with the journalist's sentiment. A similarly euphoric article by a local sports writer about a minor league sporting event, though it may be equally euphoric, may see no action at all from the same reader.

Characteristic—means lower dimensional embeddings of nodes in the graph recording Karma. We note that the overall purpose of an index or aggregate is to remove characteristics and condense them into a unified measure. Yet if we want to make predictions based on highly dimensional data, we will want to form lower dimensional embeddings of our graph to enable not merely interpretation of what has happened but what will happen and perhaps what has happened already but was not reported.

### Karma Flow Mathematical Definition

We define Karma mathematically as shown in Table 1.

TABLE 1
Karma Definition

${Karma}_{flow} = \frac{Sentiment}{\vert Sentiment \vert} \cdot \sqrt{{Goldstein}^{2} + {Sentiment}^{2} + {Strength}^{2}}$
where
Sentiment is the average tone between two entities on the graph across all
events connecting them and Goldstein is the average severity of events
between two entities on the graph across all events connecting them
and Strength is aggregate connection strength between two entities on
the graph across all events connecting them.

### Event Karma Mathematical Definition

Sometimes, we may wish to assess the Karma of an event such as it may occur at a location outside of the context of its associations. For this, we categorize Event Karma according to the “Conflict and Mediation Event Observations” (CAMEO) system. Both formulations of Karma share the use of the Goldstein scale for severity/gravity and tone as sentiment but differ in their interpretations of strength or what we have previously referred to as infusion or “echo.” Karma Flow and Event Karma are therefore not directly comparable. We define Event Karma mathematically as shown in Table 2.

TABLE 2
Event Karma Definition

${Karma}_{cameo} = \frac{Sentiment}{\vert Sentiment \vert} \cdot \sqrt{{Goldstein}^{2} + {Sentiment}^{2} + {Citations}^{2}}$
where
Sentiment is the average tone across all mentions of the Event(s) in all
citations and Goldstein is the severity of the Event(s) and
Citations are the volume of mentions the Event(s) has received and
Event(s) are the event or events at a specific longitude and latitude.

### Sentiment Bias Mathematical Definition

The news sphere has a proverb: “If it bleeds it leads,” suggesting that negative news events generate more traction than positive news events. Therefore, interpreting Karma should be done with a view towards the overall bias of the data corpus and similar corpora-either for different regions or different time frames. We define sentiment bias mathematically as shown in Table 3.

TABLE 3
Sentiment Bias Definition

$SentimentBias = \frac{{\sum }_{i = 1}^{n} \frac{Sentiment}{\vert Sentiment \vert} \cdot \sqrt{{Sentiment}_{i}^{2} + {Strength}_{i}^{2}}}{n}$
where
Sentimentᵢ is the average tone between two entities on the graph for edge
i and Strengthᵢ is the aggregate connection strength between two entities
on the graph for an edge i and n is the number of edges on the graph.

### Karma Flows Framework

The Karma Flows framework comprises the logical building blocks shown in Table 4.

TABLE 4
Karma Flows Framework
Sampling

| | |
|---|---|
| World Press Freedom Index | ESO Domain Authority |

Cross Matching

| | |
|---|---|
| Knowledge Graph | Event Data with Sentiments |

Annotating

| | | |
|---|---|---|
| World Bank Taxonomy | Goldstein Scale | CAMEO |

Core Computation

| | | |
|---|---|---|
| Karma Scope | Attention Mechanism | Graph Deep Learner |

Sampling and sub-sampling are aimed at excluding censored news and propaganda, such as might be emanating from contemporary dictatorships. All sources of information are ranked against the World Press Freedom Index. On this premise, the media of some otherwise large countries are discarded outright; data must contain information in order to be useful. Personal blogs may enjoy popularity but will have enjoyed little or no editorial vetting. Are they authoritative? For this reason, sources are vetted against their domain authority. Cross-matching relates events to entries in the knowledge graph. Events are then labelled or annotated according to our database of thousands of themes which we have manually curated according to economic relevance as well as relation to the domains of economics and government. Core computation takes place in Karma Scope in conjunction with the Attention Mechanism embedded in Karma Scope, either unguided mode or human-guided mode or guided by the neural network graph deep learner.

The knowledge graph utilizes the GDELT database. Event severity utilizes the Goldstein Scale and Conflict and Mediation Event Observations (CAMEO) classification. Themes employ, among others, the World Bank Group Topical Taxonomy. SEO Ranking for source validation utilizes domain authority.

Karma Flows is centred on its core computational engine called “Karma Scope.” Karma Scope is an iterative regularizer. This fulfils much the same purpose as an edge detection algorithm in visual image processing. Edge detection in visual image processing reveals features in an image at the expense of detail. Only shape remains. Karma Scope does the same for a temporal event graph connecting concepts and entities with Karma forming the dominant edges. Additionally, Karma Scope implements an attention mechanism, which unlike the attention mechanisms in a neural network that build up neural connections around information receiving attention, instead retains details around areas of attention in the graph as detail is otherwise iteratively removed from said graph during regularization. The attention mechanism in transformers is additive; it builds neural network connections through iterative re-weighting. The attention mechanism in Karma Scope is retentive: it retains features as a regularizer iteratively removes detail and complexity.

Graph Neighbourhood Cloud Attention is one embodiment of the Karma Scope attention mechanism whereby in addition to retaining detail around specific nodes within the knowledge graph during regularization, additional detail is retained around what we term a Neighbourhood Cloud. The best way to convey its intuition is by way of a narrative scenario. One might imagine a room full of 100 people engaged in chatter, conversations, and some might be chanting. Most people are having 1-on-1 conversations, but there are three groups of 10 persons each who are chanting in unison, louder and above the volume of all the others. Our regularizer is set to remove detail of less than 5 common voices. Therefore, after applying our regularization mechanism, we will only be hearing three chants. All else will have been removed. However, there are two persons in the room who we wish to listen to: Alice and Bob. Alice and Bob, being very shy as to their association, are speaking to each other only through Jane. The Karma Scope Graph Neighborhood Attention mechanism proceeds as follows: Firstly, Karma Scope computes the shortest path between Alice and Bob, which may be the triplet Alice-Jane-Bob or any tuple formed by including any intermediary as may be used by Jane: Alice-Jane-Intermediary/Intermediaries-Bob. The nodes Alice, Jane and Bob are marked for retention. The Graph Neighborhood Attention mechanism then marks for retention any connections along this shortest path, according to the degree (direct neighbour/neighbour once removed/neighbour twice removed/neighbour n-steps removed) of the connection and connection strength (distance) as specified by the parameters provided to the Graph Neighbourhood Cloud Attention mechanism. When the regularizer subsequently removes detail of less than 5 common voices, nodes marked for retention are retained. Consequently, we will now be hearing three chants plus the chatter between Alice, Bob and their network. This approach is very powerful in that it may be found that Jane is part of a latent graph community (a hidden group of collaborators) that includes the leading influencers of the three chanting groups and it may be further found that members of the said group have specific thematic associations within the graph, for instance, associations with political violence (negative Karma) or the arts (positive Karma). The Karma Flows framework includes all the necessary tools to analyze this, such as graph centrality computation, community detection etc. In Prior Art, it is impossible to methodically analyze a Large Language Model in this way, even though Large Language Models represent graphs and principally correspond to graphs. Karma Flows makes this possible through its unique combination of a deep learning graph model with a graph substrate and a regularizer guided by its Retention Attention mechanism all of which may execute upon commodity hardware owing to the optimizations employed by the Karma Flows framework.

### Karma Flows Centrality Measures

Karma Flows Centrality Measures are one embodiment of the Karma Flows framework. In the interactive report generated by Karma Flows, we are given an internet look-up to Wolfram Alpha, Google & Wikipedia. Internet look-ups are a convenient way to disambiguate named entities. An example report is depicted in the table below.

TABLE 5
Karma Measures of Centrality
Top 12 Influential Persons

| person | degree | lookup |
|---|---|---|
| Joe Biden | [symbol] | [symbol] Google [symbol] Wikipidia [symbol] |
| Donald Trump | [symbol] | [symbol] Google [symbol] Wikipidia [symbol] |
| [symbol] | [symbol] | [symbol] Google [symbol] Wikipidia [symbol] |
| [symbol] | [symbol] | [symbol] Google [symbol] Wikipidia [symbol] |
| [symbol] | [symbol] | [symbol] Google [symbol] Wikipidia [symbol] |
| Barack Obama | [symbol] | [symbol] Google [symbol] Wikipidia [symbol] |
| [symbol] | [symbol] | [symbol] Google [symbol] Wikipidia [symbol] |
| [symbol] | [symbol] | [symbol] Google [symbol] Wikipidia [symbol] |
| Greg Abbott | [symbol] | [symbol] Google [symbol] Wikipidia [symbol] |
| [symbol] | [symbol] | [symbol] Google [symbol] Wikipidia [symbol] |
| Elon Musk | [symbol] | [symbol] Google [symbol] Wikipidia [symbol] |
| [symbol] | [symbol] | [symbol] Google [symbol] Wikipidia [symbol] |

Top 12 Influential Organizations

| organization | degree | lookup |
|---|---|---|
| [symbol] | [symbol] | [symbol] Google [symbol] Wikipidia [symbol] |
| White House | [symbol] | [symbol] Google [symbol] Wikipidia [symbol] |
| [symbol] | [symbol] | [symbol] Google [symbol] Wikipidia [symbol] |
| Facebook | [symbol] | [symbol] Google [symbol] Wikipidia [symbol] |
| [symbol] | [symbol] | [symbol] Google [symbol] Wikipidia [symbol] |
| Supreme Court | [symbol] | [symbol] Google [symbol] Wikipidia [symbol] |
| [symbol] | [symbol] | [symbol] Google [symbol] Wikipidia [symbol] |
| [symbol] | [symbol] | [symbol] Google [symbol] Wikipidia [symbol] |
| [symbol] | [symbol] | [symbol] Google [symbol] Wikipidia [symbol] |
| Instagram | [symbol] | [symbol] Google [symbol] Wikipidia [symbol] |
| Justice Department | [symbol] | [symbol] Google [symbol] Wikipidia [symbol] |
| Google | [symbol] | [symbol] Google [symbol] Wikipidia [symbol] |

Top 12 Influential Locations

| location | degree | lookup |
|---|---|---|
| United States | [symbol] | [symbol] Google [symbol] Wikipidia [symbol] |
| [symbol] | [symbol] | [symbol] Google [symbol] Wikipidia [symbol] |
| [symbol] | [symbol] | [symbol] Google [symbol] Wikipidia [symbol] |
| Russia | [symbol] | [symbol] Google [symbol] Wikipidia [symbol] |
| Ukraine | [symbol] | [symbol] Google [symbol] Wikipidia [symbol] |
| China | [symbol] | [symbol] Google [symbol] Wikipidia [symbol] |
| Mexico | [symbol] | [symbol] Google [symbol] Wikipidia [symbol] |
| California, United States | [symbol] | [symbol] Google [symbol] Wikipidia [symbol] |
| Florida, United States | [symbol] | [symbol] Google [symbol] Wikipidia [symbol] |
| [symbol] | [symbol] | [symbol] Google [symbol] Wikipidia [symbol] |
| United Kingdom | [symbol] | [symbol] Google [symbol] Wikipidia [symbol] |
| [symbol] | [symbol] | [symbol] Google [symbol] Wikipidia [symbol] |

[symbol]

indicates data missing or illegible when filed

### Karma Flows Aura Reporting

Aura emerges around any entity in Karma Flows when many independent connections emerge around that entity. Hence, it is statistically relevant for entities with a high degree of connectedness within the graph.

### Aura Mathematical Definition

Aura is the average (arithmetic mean) of Karma Flows about an entity.

No value judgement of events nor attribution of right or wrong occurs in Karma Flows. Yet when all associations of an entity across a broad spectrum are negative, one may then infer that the Aura about this entity is negative also—at least in the localised context of the analysis and for the isolated time frame of said analysis.

Karma Flows aggregates the Aura associated with dominant themes and concepts in each analysis. Shown below are the dominant themes for the Karma Flows analysis for the United States in the month of June 2023, along with the Aura attributed to these themes.

TABLE 6
Comparative Theme Aura & Compensated Aura
Top 30 Themes & Aura

[symbol]

| Theme | [symbol] | Aura | [symbol] |
|---|---|---|---|
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |

[symbol]

indicates data missing or illegible when filed

Karma Flows calculates a “Reference Aura” which denotes the average of all auras in the analysis and hence the negativity bias built into the news mediascape at large. Compensated Aura then is the individual aura as it stands out from the Reference Aura. We might also call this the relative aura. It defines how an entity stands out relative to its peers in the analysis.

### Kernel Density Estimation and Karma Prediction

Karma Flows computes a Kernel Density Estimation (KDE) of the Probability Density Function (PDF) of the Aura of individual entities. This gives a shape and profile to each Aura and permits their comparison. In Table 7, we show sample Aura profiles for three countries.

Given two entities and their Auras, Karma Flows uses the Kernel Density Estimation method to predict the Karma for a hitherto unknown association between two entities by forming the joint KDE of their respective Auras.

Said joint KDE allows us to answer the question of what a most likely Karma value might be if we had the ability to predict the association between any two entities. This predictive ability is described in detail below.

### Minority and Majority Link Prediction

In a graph, “Link Prediction” means predicting the edges of a graph or predicting the properties of the edges of a graph. Traditional graph machine learning methods excel at computing measures of centrality and identifying latent (hidden) groups or clusters within a graph. This enables us to derive leading influencers and gauge the associations between entities.

Neural Network Graph Deep Learning goes one step further than this by learning lower dimensional embeddings of the highly dimensional data comprising the graph. This allows the prediction of associations between entities which are hitherto unrecorded—much in the same fashion as a machine learning model of a time series allows the prediction of future values in that time series. In a graph based on event data, Neural Network Graph Deep Learning affords us the ability to ask: “What either has happened already that isn't reported, or what might be happening soon?” Since our graph models the aggregated gravity and associated sentiment of events, referred to as Karma, Graph Deep Learning allows us to ask: “Where (between whom) will something significant happen?” We will not necessarily be able to know what event(s) precisely will happen, but we can form a view as to their gravity and associated sentiment. And we may be able to infer the type of thing(s) about to happen (their theme). This in turn then permits an analyst to focus their investigation on precise entities or locations, which would otherwise be prohibitive to perform in an un-focused manner across a large domain. In one embodiment of the described technology, we use GraphSAGE to implement deep learning over the Karma Flows graph.

Karma Flows then produces two reports: ‘Minority Predictions’ and ‘Majority Predictions’.

Minority Predictions detail associations which GraphSAGE deems ought not to be in the graph. In essence, it disagrees with the original graph having formed this association. Whether fake news or a contradiction of a dominant trend, GraphSAGE deems the associations in the Minority Predictions to be false. Majority Predictions detail associations which are not found in the graph, but that GraphSAGE deems ought to be present in the graph. The interpretation is that these are associations which represent events that have either gone unreported or which are very likely to happen soon. GraphSAGE deems these associations to be true.

### REFERENCED WORKS

Karma Flows, A Strategy for Measuring Social Energy Flows using Graph Computation and Artificial Intelligence, A Global Sentiment Aggregator, https://dx.doi.org/10.2139/ssrn.4550766, Christoph Kohlhepp 2023
Karma Flows Political Wire—Forecasting the US Presidential Elections 2024, https://dx.doi.org/10.2139/ssrn.4759179, Christoph Kohlhepp 2023
Attention in Psychology, Neuroscience, and Machine Learning, Grace W. Lindsay”, 2020
A Conflict-Cooperation Scale for WEIS Events Data, The Journal of Conflict Resolution, Goldstein, J. S., 1992
Sector Taxonomy and Definitions, The World Bank Group, 2016
Scaling CAMEO: Psychophysical Magnitude Scaling of Conflict and Cooperation, Journal for Foreign Policy Analysis, G. Dale Thomas, 2015
Language Models are Open Knowledge Graphs, Wang et al, arXiv: 2010.11967v1, Cornell University, 2020
GDELT—The Possibility of Global Data Sets, Journal of International Affairs, Volume 68, Kalev Leetaru, 2014

1. A computer-implemented method for event prediction based on aggregated sentiment in graph machine learning, comprising:
a) providing a computer processor for processing data;
b) providing at least one input device;
c) providing at least one output device;
d) providing a computer readable storage device;
e) providing a knowledge graph comprising:
i) a plurality of news events,
ii) a plurality of entities associated with said news events,
iii) a plurality of sentiments associated with said news events;
f) providing a formula for karma configured to execute on said computer processor and configured to compute said karma in terms of said aggregated sentiment between any two entities on said knowledge graph for said news events connecting said any two entities and aggregated severity of said news events and aggregated connection strength between said any two entities;
g) providing a knowledge graph regularizer executed on said computer processor configured to:
i) access said computer readable storage device for reading said knowledge graph,
ii) access said computer readable storage device or said input device for reading tuning parameters,
iii) transform said knowledge graph to a reduced knowledge graph according to said tuning parameters wherein said knowledge graph is filtered of noise in its data,
iv) store said reduced knowledge graph on said computer readable storage device using a reduced amount of storage in said computer readable storage device or write said reduced knowledge graph to said output device; and
whereby said regularizer elicits dominant relationships in said knowledge graph from said reduced knowledge graph through a system of logic and outputs said dominant relationships to said storage device.

2. The computer-implemented method of claim 1, further providing a formula for sentiment bias configured to execute on said computer processor and configured to compute said sentiment bias for said knowledge graph in terms of the average of all aggregated sentiments between any two entities on said knowledge graph for news events connecting said any two entities and aggregated connection strength between said any two entities and configured to write said sentiment bias to said storage device whereby a human investigator is able to interpret any news sentiment relative to said sentiment bias which reflects the negativity bias present in news media.

3. The computer-implemented method of claim 1, wherein said regularizer using said knowledge graph and using said karma is further configured to relate past events to persons, entities or concepts whereby human investigators are able to attribute both likely endorsement and likely blame for said news events recorded in said knowledge graph.

4. The computer-implemented method of claim 1, wherein said regularizer using said knowledge graph and using said karma is further configured to identify latent groups of persons, entities or concepts connected by said news events in said knowledge graph whereby human investigators are able to identify likely collaborators.

5. The computer-implemented method of claim 1, further providing a graph attention mechanism configured to execute on said computer processor and wherein said regularizer using said knowledge graph and using said karma is further configured to receive attention parameters identifying sections of said knowledge graph to be retained while constraining said knowledge graph according to said tuning parameters wherein said knowledge graph is shaped focused on said sections of said knowledge graph whereby a human investigator conducting an analysis is able to zoom in upon specific relationships embedded in said knowledge graph.

6. The computer-implemented method of claim 1, further providing a neural network graph model configured to execute on said computer processor configured to:
i) access said computer readable storage device for reading said knowledge graph,
ii) deduce a lower dimensional embedding of information contained within said knowledge graph wherein said neural network graph model forms a substrate of said knowledge graph and wherein said neural network graph model is able to deduce relationships which are not explicitly recorded within said knowledge graph,
iii) make predictions about relationships representing events between said entities within said knowledge graph,
iv) store said predictions on said computer readable storage device or write said predictions to said output device;
and
whereby said neural network graph model is able to furnish predictions about events between entities which either have occurred but have not been reported in news media or about events which will occur in the future or about events which have been falsely reported in news media or about fake news events.

7. The computer-implemented method of claim 1, further providing a graph attention mechanism configured to execute on said computer processor wherein said regularizer using said knowledge graph and using said karma is further configured to receive attention parameters identifying sections of said knowledge graph to be retained while constraining said knowledge graph according to said tuning parameters wherein said knowledge graph is shaped focused on said sections of said knowledge graph and further providing a neural network graph model executed on said computer processor configured to:
i) access said computer readable storage device for reading said knowledge graph,
ii) deduce a lower dimensional embedding of information contained within said knowledge graph wherein said neural network graph model forms a substrate of said knowledge graph and whereby said neural network graph model is able to deduce relationships which are not explicitly recorded within said knowledge graph,
iii) furnish said regularizer with said attention parameters which identify sections of said knowledge graph to be retained while constraining said knowledge graph wherein said knowledge graph is shaped focused on said sections whereby an analysis is able to zoom in upon specific relationships embedded in said knowledge graph
and
whereby said neural network graph model is able to guide said regularizer without human intervention to focus on specific relationships embedded in said knowledge graph which enables handling larger data sets through said lower dimensional embedding than said knowledge graph would be expected to handle on its own while retaining the mathematical structured interpretability of a graph model.

8. The computer-implemented method of claim 1, further providing a neural network graph model configured to execute on said computer processor configured to:
i) access said computer readable storage device for reading said knowledge graph,
ii) deduce a lower dimensional embedding of information contained within said knowledge graph wherein said neural network graph model forms a substrate of said knowledge graph and whereby said neural network graph model is able to deduce relationships which are not explicitly recorded within said knowledge graph,
iv) store said predictions on said computer readable storage device or write said predictions to said output device;
and wherein said knowledge graph executed on said computer processor is further configured to utilize kernel density estimation to calculate the predicted karma for said predictions about relationships representing events as furnished by said neural network graph model using as inputs values of said karma as computed by said formula for karma for said entities involved in said predictions about relationships representing events and store said predicted karma on said storage medium whereby human investigators are able to rank and measure the relative significance of said predictions about events.

9. The computer-implemented method of claim 1, further providing a formula for aura wherein said formula is executed on said computer processor and is configured to compute said aura specific to any entity on said knowledge graph as the average of all said karma as computed by said formula for karma for said entity whereby a human investigator is able to rank and measure the relative significance of any entity on said knowledge graph in terms of its average karma.

10. The computer-implemented method of claim 1, wherein said knowledge graph executed on said computer processor is further configured to utilize maximum graph flow calculated based on said karma to compute the relatedness between concrete entities, such as persons or countries or organizations, to thematic entities representing abstract concepts, such as economic volatility or security threats, and store said relatedness on said storage medium or write said relatedness to said output device whereby human investigators are able to rank and measure the relative significance of entities, such as persons or countries or organizations, to said thematic entities.
